(19) United States
(12) Patent Application Publication
(10) Pub. No.: US 2013/0327589 A1
(43) Pub. Date: Dec. 12, 2013

(54) ISOLATION AND BARRIER TYPE SOUND TREATMENT DEVICES

(71) Applicant: Auralex Acoustics, Inc., Indianapolis, IN (US)

(72) Inventors: Eric Smith, Indianapolis, IN (US); David Fischer, Indianapolis, IN (US); Mark Kauffman, Indianapolis, IN (US); Benjamin Carlisle, Indianapolis, IN (US)

(21) Appl. No.: 13/916,369

(22) Filed: Jun. 12, 2013

Related U.S. Application Data
(60) Provisional application No. 61/658,631, filed on Jun. 12, 2012.
(60) Provisional application No. 61/658,645, filed on Jun. 12, 2012.
(60) Provisional application No. 61/658,548, filed on Jun. 12, 2012.

(51) Int. Cl. G10K 11/00

(52) U.S. Cl. CPC G10K 11/002
USPC 181/290

(57) ABSTRACT

An acoustic isolator is capable of being placed on a resting surface and receiving a sound producing device. The acoustic isolator includes a sheet like barrier member having a first surface and a second surface and a thickness of less than about 0.375 inches. The barrier member is composed of a plastic material. A sheet like fiber based fabric member has a first surface coupled to the second surface of the barrier member to form a laminated sheet having at least two layers. Also, a paintable acoustic barrier sheet is capable of being attached to and covering a room surface member, and receiving a paint material to permit the user to choose the color of covered room surface member by applying paint thereto. The paintable acoustic barrier comprises a sheet like barrier member having a first surface, a second surface and a thickness of less than about 0.2 inches. The barrier member is comprised of a first plastic material. A sheet like plastic barrier second member is composed of a second plastic material and has a first surface coupled to the second surface of the barrier member to form a laminate having at least two layers, and a second surface. The second surface is capable of receiving paint in a manner that permits the paint to adhere to the first surface in an even aesthetically pleasing manner.

### PRIORITY STATEMENT

The present invention claims benefit of priority to Smith et al., U.S. Provisional Application No. 61/658,548 filed on 12 Jun. 2012; Smith et al., U.S. Provisional Application No. 61/658,631 filed on 12 Jun. 2012; and Smith et al., U.S. Provisional Application No. 61/658,645 filed on 12 Jun. 2012, all of which are fully incorporated herein by reference.

### I. TECHNICAL FIELD OF THE INVENTION

The present invention relates to sound treatment devices that help to shape, treat, modify, or otherwise control sound in a space. More particularly, one aspect of the present invention relates to an isolator that is placeable between a sound-producing device such as a drum set and a resting surface, such as a stage, to create acoustical isolation and an acoustic barrier between the sound-producing device and the resting surface. Additionally, another aspect of the present invention relates to a sound treatment device that helps to prevent sound produced in a first space from traveling to an adjacent space.

### II. BACKGROUND OF THE INVENTION

The genesis of sound is the generation of vibrational waves of one or more frequencies that occur within the hearing range. To produce sound, a variety of sound-producing devices exist. These sound-producing devices include such things as speakers, monitors and musical instruments. Sound produced by sound-producing devices is carried through a medium (usually air) to the ear of the user, who then hears the sound.

However, the sound waves travel not only through the air, but also affect building structures such as walls, floors, ceilings and the like, and also will affect devices and objects within the building structure, such furniture items, floor coverings, rugs, couches, appliances, stages, windows and other items within a particular space.

When a sound wave strikes an object, that sound wave may be reflected off of the surface of the object, may pass through the object, or may be absorbed by the object. This absorption may cause the sound wave to dissipate, or may result in the sound wave inducing a vibration in the object.

In other cases, the sound will be able to travel through a surface, such as traveling through a floor. When a sound travels through an object, such as a floor, several things will happen to the sound that are usually adverse to those within hearing range of the sound. For example, the sound can induce a vibration in the object.

One type of object that is susceptible to having vibration induced in it by sound producing devices are resting surface bodies upon which sound producing devices are placed. For example, theaters, auditoriums, concert venues, churches and hospitality businesses often employ sound producing devices such as musical instruments, amplifiers and speakers to produce loud, vibration intensive sounds. Usually these sound producing devices are placed on a resting surface, such as a floor, stage, platform, etc., wherein the intimate relation between the sound producing device and the resting surface will induce vibrations in the resting surface. These resting surfaces pick up the vibrations from the sound-producing device such as a speaker, and begin vibrating in response to the vibrations of the sound-producing device.

Typically, these vibrations that are induced into the resting surface change the nature of the sound significantly enough to alter the overall quality of the sound of being produced. Often, the change is not for the better.

Therefore, in many cases, there is a desire to acoustically isolate the sound-producing device from its resting surface, to thereby prevent the vibrations produced by the sound-producing device from causing vibrations in the resting surface. One device that provides such an acoustical isolation is the MOPAD acoustic isolator device that is manufactured and sold by Auralex Acoustics. Inc. of Indianapolis, Ind., 46256. Auralex is the assignee and applicant of the instant invention. The MOPAD device is described in Smith et al. U.S. Pat. No. 6,845,841.

Another acoustic isolation device described in the Smith '841 patent is the GRAMMA device, which is well-suited for holding speaker cabinets and the like and acoustically isolating them from their resting surface. The GRAMMA device includes a board member that is covered over with a mineral fiber-based carpet-like member, and which rests upon dense foam supports.

A third acoustic isolation device that performs its function well is the HOVERDECK™ product that is also manufactured by Auralex Acoustics, Inc. The HOVERDECK platform comprises a drum riser that is formed from a series of modular member units each have a resting surface area of approximately four square feet. HOVERDECK modular units are designed to be coupled together to form resting surfaces, such as risers of an appropriate dimension to hold a sound producing device such as a full drum set.

The HOVERDECK is employed to deal with the sound issues caused by the propensity of stages and traditional drum risers to sympathetically vibrate (resonate) with the drums and/or other sound producing devices, such as amplifiers, speakers and public address systems that are placed upon the HOVERDECK platform. This induced resonance is fed back to the drums and can then be picked up by microphones that are placed on the resting surface, such as the microphones employed to pick up the drum sounds. The Auralex HOVERDECK is specifically engineered to reduce coloration from floor resonance by decoupling the sound producing device (e.g. drum kit) from the resting surface structure. This decoupling results in a more pure sound for both studio and live performances.

Auralex advertises the HOVERDECK as freeing the user from the evils of hollow stages resonating with a muddy rumble, or concrete floors sucking the tone out of a kick drum and floor tom. HOVERDECK's rugged MDF laminate core and granular rubber like ISO-Puck modular feet minimize structure-borne sound transmission and sympathetic vibrations between drums and hardware, resulting in the drums having an enhanced rumble-free purity of tone. Examples of HOVERDECK™ platforms can be seen at www.Auralex.com.

Another device that is commonly used by drummers to try to achieve some isolation between their drum set and the stage is a common carpet or throw rug, of the type that one might find at any carpet store. Although such carpets do have some sound absorbing capabilities, they do not serve very well as barriers. The rather small diameter ends of the legs of some sound producing devices, such as drum stands, drum legs, cymbal stands and the like are capable of exerting a sufficient pressure on the carpet, to permit sound and vibrations to be transmitted to the stage underneath the carpet.

Although the above-described devices all perform their function in a highly satisfactory manner, room for improvement still exists. In particular, room for improvement exists in providing a sound isolating barrier for use with a sound producing device, such as a drum set or PA system that is lighter weight, more portable, and quicker to set up and break down than some known isolators.

Therefore, one object of the present invention is to provide such a device.

Another type of sound treatment device is a sound isolator that may, in some cases consist of a sound barrier. One type of sound barrier or isolator consists of a sheet of material that resists the passage of sound energy there through. The material sheet is often placed on a room surface member such as a wall, floor, ceiling or the like, and is used with acoustically isolating construction techniques, to help prevent sound that is being created in a first room from traveling through the walls, floors or ceiling to a second room.

Construction techniques can include things such as placing air spaces between rooms, and using a second barrier within the air space so that sound that travels through the air space must pass through two barriers rather than a single barrier. Another construction technique is to use additional sound barrier materials, such as employing two sheets of drywall to form a wall, rather than the traditional single sheet.

One such sound barrier known to the Applicant is the Applicant's SHEETBLOK™ sound barrier that is sold by the assignee and Applicant of the instant invention, Auralex Acoustics, Inc. The SHEETBLOK™ sound barrier is a construction grade sound barrier product that comprises a thin, dense, rubber or plastic-like isolating material in a sheet form. When the Applicant's SHEETBLOK™ sound barrier is incorporated into the construction of a room, the SHEETBLOK™ sound barrier serves as a highly effective means for creating a sound barrier between adjacent rooms.

Unfortunately, the SHEETBLOK™ has some drawbacks in its use. The SHEETBLOK™ is typically affixed to the frame of a room, and is placed underneath the drywall that is used as the wall surface of the room. The combination of the drywall and the SHEETBLOK™ sound barrier, provides a good sound barrier.

The SHEETBLOK™ sound barrier is placed interiorly of the drywall, because the SHEETBLOK™ generally has a less than pleasing aesthetic appearance. Therefore, the drywall is placed on top of the sound acoustic barrier, so that the user can treat the drywall by painting it, placing wallpaper on it or the like, to give the room a more pleasing, aesthetic appearance.

As an alternative to placing the SHEETBLOK™ sound barrier underneath a single sheer of drywall, the SHEETBLOK™ sound barrier can be used in a “drywall sandwich”, wherein the SHEETBLOK™ sound barrier is placed on the exterior surface of an existing drywall sheet within a room. Another drywall sheet is then fixedly coupled over the original drywall sheet, so that the SHEETBLOK™ sound isolating material comprises the “meat” in a sandwich wherein the two drywall sheets comprise the bread that thereby sandwich the SHEETBLOK™ sound isolating material between the drywall sheets.

The above described construction arrangements for using a SHEETBLOK™ sound barrier have proven to provide a fine sound barrier. However, although the construction arrangements described above are easy and simple to install when creating new room construction, they have certain drawbacks in retrofit situations. In particular, retrofitting a room according to the first construction technique usually requires that the drywall be removed from the room, the SHEETBLOK™ sound barrier be attached to framing members, and then new drywall be installed over the SHEETBLOK™ sound barrier.

According to the second technique, the SHEETBLOK™ sound barrier material is placed over the original drywall, with a second sheet of drywall being placed over the SHEETBLOK™ sound barrier material. In addition to requiring the user to install a second layer of drywall, the finished product can be less than pleasing since the additional thickness added by the second sheet of drywall, shrinks the room slightly, along with potentially making the room look odd, since the second sheet of drywall often does not match up with the proper, depth (or height) of the moldings within the room.

It is therefore, one object of the present invention to provide a sound isolating barrier material that has better retrofit installation capabilities and qualities than the known prior art.

### III. SUMMARY OF THE INVENTION

In accordance with the present invention, an acoustic isolator is capable of being placed on a resting surface and receiving a sound producing device. The acoustic isolator comprises a sheet like barrier member having a first surface and a second surface and a thickness of less than about 0.375 inches. The barrier member is comprised of a plastic material. A sheet like fiber based fabric member has a first surface coupled to the second surface of the barrier member to form a laminated sheet having at least two layers.

Preferably, the barrier member comprises a mineral loaded ethyl vinyl acetate member having a thickness of approximately between an eighth of an inch (0.125 in) and three eights of an inch (0.375 in). The fabric layer preferably comprises material similar to the non-woven fabric of a fabric trunk liner. This trunk liner material is highly durable, resistant to staining and has a non-slip surface of the type that will help persons walking on this surface from slipping and falling.

In a most preferred embodiment, the fiber based fabric member comprises a solution dyed, non-woven staple fiber containing fabric having sufficient flexibility to permit the isolator to be rolled up and placed in a sack like container for transportation and storage. Additionally, the device should be light enough so that when a mat that is large enough to accommodate a full set of drums on its upper surface (approximately six feet in width by four feet in depth), the barrier mat will still be light enough to weigh less than about 30 pounds.

One feature of the present invention is that it provides a sound barrier that helps to acoustically decouple the sound producing instrument resting on the device from the stage or floor surface upon which the device rests. By decoupling the sound producing device from the resting surface, such as the stage, the sound of the sound producing device is optimized. The sound is optimized by minimizing resonance from the surface on which the sound producing device is resting. This helps to purify the tone produced by the sound producing device instantly, resulting in a more focused and more pure produced sound.

Another feature of the present invention is that it is lightweight, highly portable and very quick to set up and break down. Preferably, the device of the present invention is flexible enough to be rolled up into a roll and deposited into a cinch sack for carrying. Optimally, the device weighs less than about 30 pounds when made into standard size.

The device can be set up by simply being removed from its cinch sack storage container and unrolled like a carpet onto the spot on the resting surface at which the sound producing device will be placed. For break down, the process is reversed, so that the mat-like device can be simply rolled up very quickly and/or folded (if necessary) and replaced into the cinch sack, and then carried to either its storage area or the musical equipment transport vehicle. This set up and take down procedure represents a significant improvement when compared to the set up and take down procedure attendant to the use of a product such as the aforementioned HOVERDECK platform. As discussed above, the HOVERDECK modular decking product performs its intended function in a highly workmanlike and well respected manner. However, the HOVERDECK does require more time and effort to set it up and take it down than the present invention.

In accordance with another aspect of the present invention, a paintable acoustic barrier sheet is capable of being attached to and covering a room surface member, and receiving a paint material to permit the user to choose the color of covered room surface member by applying paint thereto. The paintable acoustic barrier sheet comprises a sheet like barrier member for serving to reduce the passage of sound energy there through having a first surface, a second surface and of a thickness of less than about 0.2 inches. The barrier is comprised of a first plastic material. The barrier sheet also includes a sheet like plastic second paintable member that is comprised of a second plastic material. The second paintable member has a first surface coupled to the second surface of the barrier member to form a laminate having at least two layers, and a second surface. The second surface is capable of receiving paint in a manner that permits the paint to adhere to the first surface in an even aesthetically pleasing manner.

In a preferred embodiment of the present invention, the sheet-like barrier member is preferably comprised of an ethylene vinyl acetate material that is mineral loaded. In some references, this material is referred to as a mass loaded vinyl. Additionally, in a preferred embodiment, the paintable second member comprises a PVC (polyvinylchloride) plastic material that has a Class A fire rating per ASTM-E84-90a.

The material is formed in a sheet, so that it is flexible, and generally can be delivered in a roll form. In a most preferred embodiment, the barrier member is made to be approximately 0.125 inches in thickness and the paintable member is made to be approximately 0.022 inches in thickness.

One feature of the present invention is that it provides a sound barrier surface that is aesthetically pleasing. Because the plastic paintable layer enables the surface to be painted, the acoustic barrier material can be nailed, glued or otherwise affixed to the room facing surface of the drywall, concrete, stucco, plaster or other material of which the walls of a room are formed. The paintable surface can then be painted with conventional room paint. Through this painting, the acoustic barrier material of the present invention will assume an appearance not unlike one would expect of a normal wall. Additionally, the sound barrier and the paintable layer can accept wallpaper, if so desired, thus increasing the user's aesthetic flexibility.

Another feature of the present invention is that the barrier layer of the present invention can be applied to a room without the significant construction issues that often accompanied the application of prior art barriers known to the Applicant.

Because of the aesthetically pleasing nature of the present invention, it can be placed directly on the room facing surface of drywall, plaster, stucco or the like, and then painted over to produce an aesthetically pleasing wall surface. This contrasts with the prior art, that was not as capable of producing such an aesthetically pleasing surface. Because of this inability to create an aesthetically pleasing wall surface, the user of prior art barrier sheets were barrier sheets were usually required to place the barrier sheet on the underside (stud-facing) surface of the drywall. In retrofit applications, this usually required that either the existing drywall be removed and then replaced over the newly installed barrier sheet; or alternately, that an additional layer of drywall be placed over the barrier sheet.

In either case, the removal or erection of drywall in the room was required during the installation of the barrier sheet in order to achieve good aesthetic properties. In contrast, the present invention does not require the removal or erection of any drywall layers.

These and other features of the present invention will become apparent to those skilled in the art upon a review of the drawings and detailed description presented below, that represent the best mode of practicing the invention perceived by the Applicant at the present time.

### IV. BRIEF DESCRIPTION OF THE DRAWINGS

FIG. 1 is a perspective view of the barrier mat of the present invention being used as a resting surface for a drum set;

FIG. 2 is a perspective view of a roll of the barrier mat of the present invention;

FIG. 3 is a sectional view taken along lines 3-3 of FIG. 2;

FIG. 4 is a side view of the cinch sack of the present invention;

FIG. 4A is a perspective, exploded view;

FIG. 5 is a perspective exploded view of an alternate embodiment barrier sheet material of the present invention;

FIG. 6 is a side, schematic view, greatly enlarged, of the alternate embodiment barrier sheet of the present invention;

FIG. 7 is a sectional view of the alternate embodiment barrier sheet of the present invention, shown as being applied to a wall including a sheet of drywall, and a stud support frame member, and

FIG. 8 is a sectional view of the present invention being applied to a room surface member with an adhesive.

### V. DETAILED DESCRIPTION OF THE PREFERRED EMBODIMENT

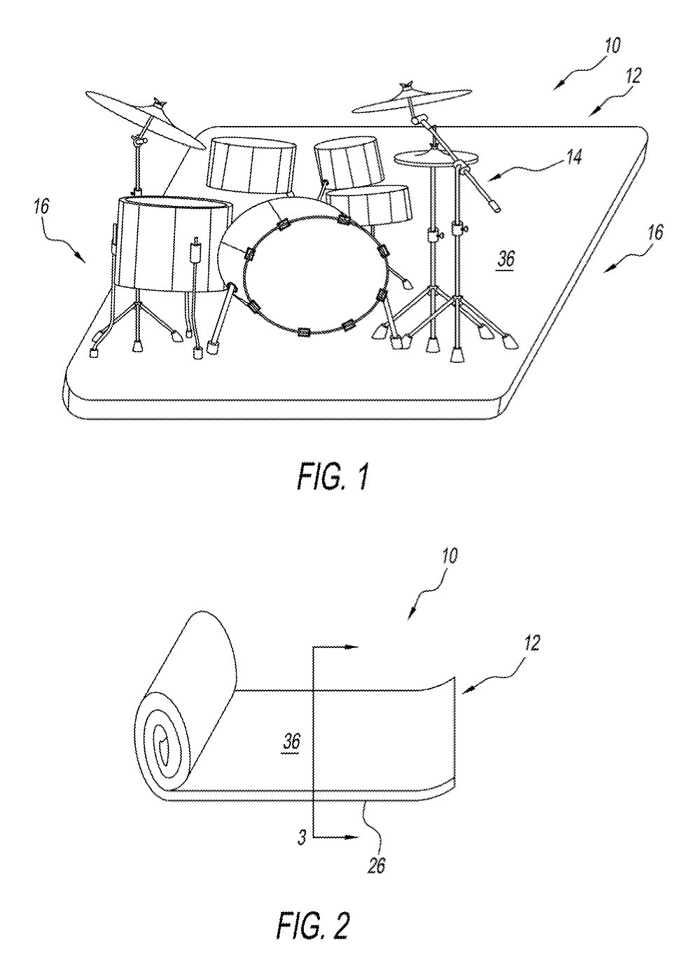

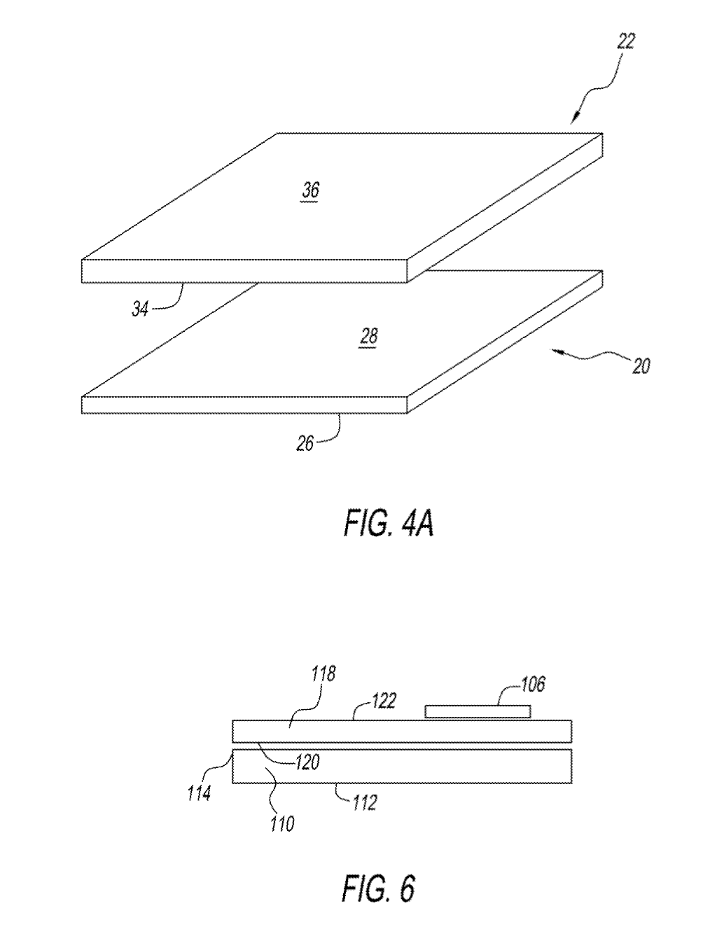

The acoustic isolator 10 of the present invention is best shown in FIGS. 1-4A as comprising an acoustic isolator mat 12 having an upper surface on which a drum set 14 can rest, and a lower surface that is placeable on a resting surface 16 such as a floor, stage or the like. The acoustic isolator 10 has a generally mat-like configuration 12, insofar as it is generally sheet like, flexible and is capable of being rolled and/or folded. Typically, the thickness of the sheet like mat 12 is approximately 0.375 inches or less. In a first, casual glance, the mat 12 has an appearance similar to the appearance of an area rug or mat.

The mat 12 is a multi-layered laminate that includes a barrier member 20 that, in normal use, underlays an upper, fabric member 22. The barrier member 20 and fabric member 22 join together to form a laminate having at least two layers. As will be appreciated, additional layers of materials could be added to make a multi-layered laminate. However, one of the benefits of the present invention is that the two-layer laminate of the present invention achieves a high degree of acoustic isolation, while still remaining very flexible, very light weight and reasonably inexpensive to manufacture. As such, when constructing a laminate having additional layers, it would be helpful to balance whatever additional benefits are provided by the additional layers, against the additional cost, weight and/or lack of flexibility that might result from the use of additional layers.

The barrier layer 20 is generally comprised of a mineral loaded plastic sheet, and includes a first or lower surface 26, and a second or upper surface 28. The fabric member 22 is preferably comprised of a non-woven fabric, and includes a first or lower surface 32 that is fixedly attached, such as by gluing, heat bonding or the like to the second or upper surface 28 of the barrier 20. The fabric member 22 also includes an upper surface 36 that serves as the upper surface of the mat 12, and upon which the sound producing device, such as the drum set 14 (FIG. 1), is shown.

Although the mat 12 is shown as holding a drum set 14 on its upper surface, the mat 12 can also accommodate a large number of other types of sound producing devices. For example, the mat is designed to serve as a resting surface for sound producing devices such as speakers, monitors, amplifiers, other musical instruments such as keyboards, band stands and any other type of device that either produces sound, or is subject to vibration and rattling, and as such, may induce unwanted sounds or noises into the sound being produced in the area. Although the mat 12 is usually associated with and used with a fixed position instruments such as keyboards and drums, the mat 12 also has great utility as a mat for stand up musicians, such as guitarists, vocalists and horn players.

Most “stand up” type musicians will typically employ a monitor placed close to their position on the stage that of course, constitutes a sound producing device, along with the microphone stand for vocalizations. The mat 12 of the present invention serves well in such situations, enabling the musician to place his monitor, guitar stands, microphone stands, horn stands, etc., on the mat during a performance, to prevent the sound producing and vibration induced devices from causing vibrations of the resting surface upon which they rest, and thereby muddying or otherwise distorting the sound produced by the instruments.

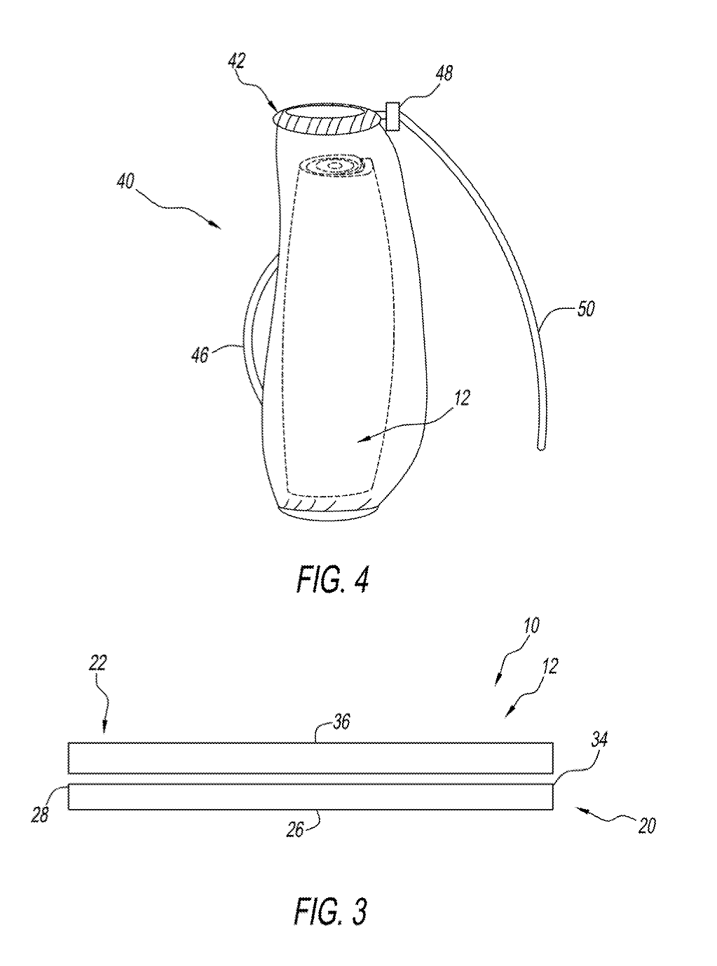

As shown in FIG. 2, the device is designed to be easily rolled up into a roll, similar to a small carpet roll. As the device is preferably less than about 0.375 inches in thickness, the mat can be rolled up quiet easily, to cause the mat to roll up into a rather tight roll. Preferably, the roll is sized so that when fully rolled up, the rolled mat 12 can be inserted into a cinch sack 40 that is shown in FIG. 3.

The cinch sack 40 includes a draw string opening 42 and a handle 46. The cinch sack 40 serves as a storage and transportation device. At the end of a performance, the user can roll up the mat 12 as shown in FIG. 2 and place it in the cinch sack 40 using the string grabbing device 48, to position the grabber on the string 50 to maintain the draw string opening 42 in a closed position. The user can then grab the cinch sack 40 with a handle 46, to move the mat 12 from the stage, to either its storage place within the building or on to a transportation vehicle, such as a truck, van or the like, to transport the mat 12 along with the rest of the band's equipment to either the band's headquarters, or else, their next performance site.

Most preferably, the mat 12 has a size of about approximately four feet by six feet and is sufficiently lightweight, so that a mat of the present invention, when made in this sized configuration weighs generally less than 30 pounds (preferably about 28 pounds), thus making it easily transportable. Although the mat 12 can be made in any size, it has been found by the Applicants that a four foot by six foot (24 sq. ft.) size is generally most appropriate and fitting for holding a full drum set.

The barrier layer 20 preferably comprises a plastic layer similar to SHEETBLOK material that is produced by Auralex Acoustics, Inc., the Assignee of the instant invention. In particular, the SHEETBLOK barrier material comprises a mineral loaded ethyl vinyl acetate sheet having a thickness of about 0.125 inches or so. It has been found by the Applicants that this particular material, in this particular thickness, serves as a fine acoustic isolator and barrier to thereby prevent vibrations created by a sound producing instrument such as drums 14 that are resting upon the upper surface of the mat 12 from inducing sympathetic vibrations and resonance in the resting surface 16 on which the mat 12 of the present invention rests, such as a stage, concrete floor or the like.

The lower surface 26 of the barrier member 20 includes no coating over the surface 26 as it is designed primarily to rest on the stage or other resting surface. Optionally, some sort of non-skid coating or non-slip material can be applied to lower surface 26. The upper surface 28 is adhesively coupled to the lower surface 34 of the fabric member 22.

The fabric member 22 preferably comprises a reasonably dense, rugged synthetic fiber based fabric material that is similar in configuration to the matting commonly found in automobile trunks. One such material is known as OZITE that is manufactured by Foss Manufacturing Company. OZITE is described as a material that comprises a solution dyed polyester or polypropylene fabric.

Preferably, the fabric is made from post consumer recycled materials. Additionally, the fabric may include a fire retardant so that the device is fire resistant and optimally, has a Class fire rating per ASTM-E84-90a. Further, one or more antimicrobial agents, such as silver are incorporated into the fabric of fabric member 22 to reduce the growth of mold and mildew and the like.

The fabric like nature of the fabric member 22 helps to absorb sound, and helps to impart a slip resistant quality to the mat 12 so that one walking on the upper surface 36 of the mat 12 is less likely to slip or fall. Additionally, the non-woven, staple fiber product used in connection with the present invention is durable, and is easily cleaned, to help resist staining and to help resist wear and tear.

One of the benefits of using the present invention is that since it is a non-woven fabric, the fabric used as the fabric member 22 of the present invention will not unravel and is easy to cut and mold to desired shapes, if molding is so required or desired.

The barrier member 20 preferably comprises a vinyl acetate member, and preferably comprises a mineral loaded ethyl vinyl acetate barrier member, similar to the SHEETBLOK device sold by the Applicant of the present invention. Preferably, the mat 12 itself has a thickness of between about 0.125 inches and 0.35 inches. The basic fabric member 23 may be made from a variety of fibers, although it preferably comprises one of a polyester fiber predominant fabric and a polypropylene fiber predominate fabric. As also discussed above, the present invention lends itself well to the use of recycled materials.

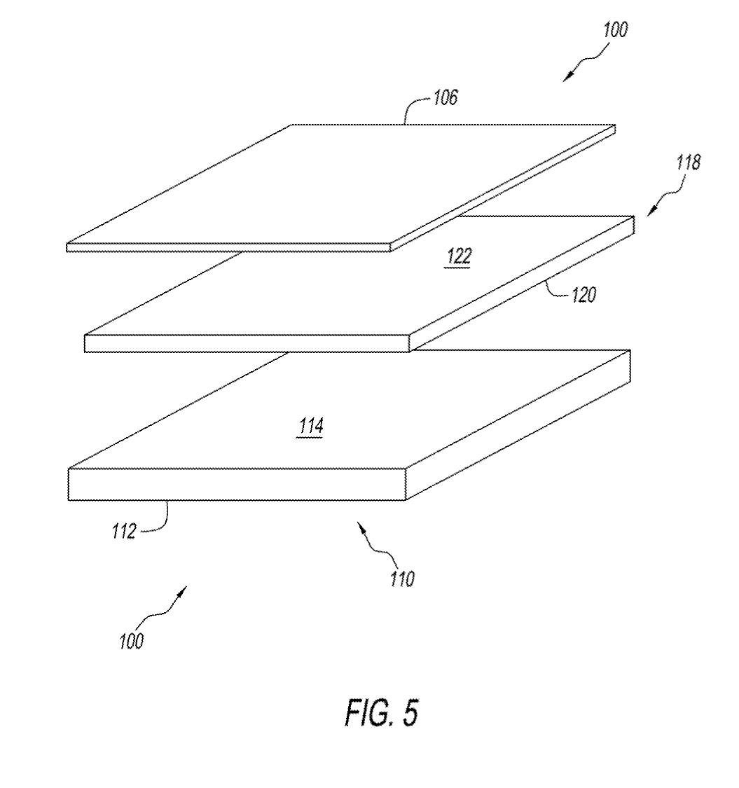

The second embodiment 100 of the present invention is shown in FIGS. 5-8. The embodiment shown in FIGS. 5-8 comprises a paintable barrier sheet 100 that is attachable to a room surface member, such as a drywall sheet 102 that is fixed onto a wall of a room. Additionally, the portable barrier sheet 100 can be placed over other room surface members, such as floor, ceilings and the like. Because the barrier sheet 100 is generally opaque (such as by painting) it is likely that the barrier sheet 100 will not often be placed over windows, although one could place the barrier sheet 100 over a window so long as one did not mind giving up the view provided by the window.

The paintable barrier sheet 100 is designed so that it can be paintable, to receive a coating of paint 106 on the surface of the paintable barrier sheet 100. The ability to receive paint in an aesthetically pleasing manner increases the flexibility and desirability of the barrier sheet 100, since it can be placed over the existing drywall, floor or ceiling on an interior surface of the room. As discussed in more detail in the Background and Summary of the Invention portion of the instant application, the prior art barrier sheets often require that the sheet be placed under a layer of drywall to hide the sheet, since the color of the sheet was not changeable, and the sheet itself did not necessarily have desirable aesthetic features, although the sheet did perform its intended function of serving as an acoustic barrier in a workmanlike manner, when the sheet purchased was Auralex's SHEETBLOK type barrier sheet.

The barrier sheet 100 of the present invention comprises a two component laminate that includes a first member that comprises a plastic barrier member 100 and a second member that comprises a paintable member 118. The barrier member 110 is generally planar and flexible sheet-like in configuration, and is preferably made from a plastic, such as an ethyl vinyl acetate plastic. In particular, the barrier member 110 is preferably made of a mineral loaded ethyl vinyl acetate polymer. The barrier member 110 includes a first or lower surface 112, and a second or upper surface 114. The barrier member 110 is designed for serving to reduce the passage of sound and energy through the barrier 110. Preferably, the barrier sheet 100 has a thickness of between about 0.125 inches and about 0.250 inches.

The second member of the paintable barrier sheet 100 comprises a paintable member 118. The paintable member 118 also includes a first or lower surface 34 and an upper surface 36. The lower surface 34 is coupled such as by gluing, heat bonding or the like, to the upper surface 28 of the barrier member 20, so that the final barrier sheet 100 comprises the two component laminate. If desired, additional layers of materials can be added.

However, it will be appreciated that the addition of additional layers to the laminate will likely increase the cost, weight and stiffness of the barrier sheet 100. As such, these considerations should be taken into account when deciding whether to add additional layers, in view of the fact especially that the two layer laminate sheet 100 of the present invention works so well. The barrier sheet 100 is preferably sufficiently thin and flexible so that it can be provided in roll form in a manner similar to the way that wallpaper is provided.

As shown in FIG. 8, an adhesive layer 126 can be applied to the underside surface 112 of the barrier member 110 to adhesively attach the paintable barrier sheet 100 to a wall. In this regard, the adhesive helps to increase the functionality of the barrier sheet 100, as it enables the barrier sheet 100 to be attached to a room surface such as drywall 102 in a manner not unlike the manner in which wallpaper is attached to a drywall surface.

The paintable member 118 preferably comprises a sheet of a polyvinyl chloride plastic. The polyvinyl chloride plastic material should be designed, or have materials incorporated therein, to give the plastic polyvinyl chloride material from which the paintable member 118 is made a class A fire rating per ASTM-E84-90a. The use of a class A fire rating helps to make the barrier sheet 100 more acceptable in buildings, and especially those buildings that attract large crowds, such as theaters.

The paintable member 118 preferably has a thickness of about 0.022 inches. It has been found by the Applicants that the use of this particular polyvinyl chloride provides a surface that does a fine job of accepting paint, and accepts paint in an aesthetically pleasing manner. Those familiar with painting will recognize that certain plastics do not accept paint in an aesthetically pleasing manner because of their surface conditions, and cause paint to appear splotchy and the like when so applied.

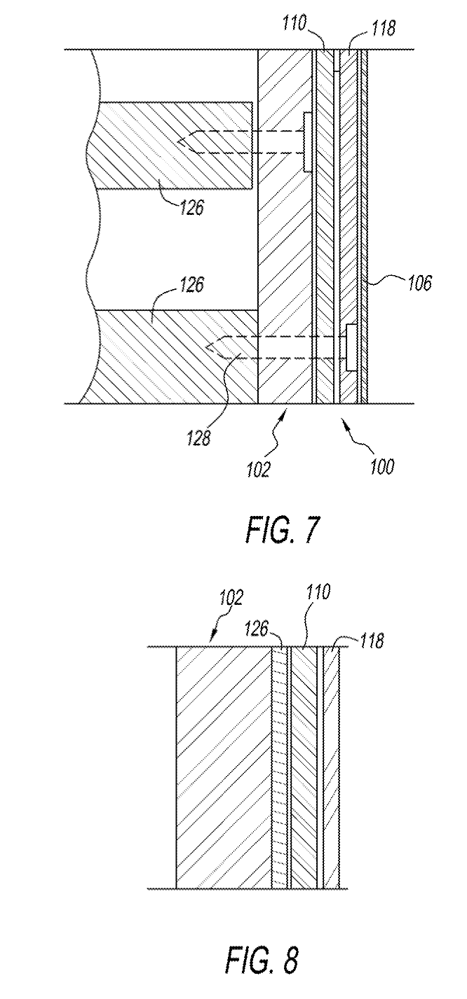

The barrier sheet 100 of the present invention can be attached to a room surface member such as drywall 102 by a variety of means, such as nailing, stapling, or gluing (FIG. 8). In FIG. 7, the paintable barrier sheet 110 is shown as being nailed to the drywall and underlying studs 126 through nails 128. The exact type of attachment utilized will vary depending upon the wall surface. Although drywall 102 does a fine job of receiving nails, such as nails 128, other wall materials such as concrete and cinder block do not accept nails as well, and may be better served through the use of an adhesive attachment.

It will also be appreciated that the techniques for attaching the paintable barrier material 100 to a surface of drywall 102 are similar to those considerations that would apply to the application of wallpaper. In particular, one would wish to apply the barrier in a manner that is flat, and is bubble free, wrinkle free and the like, so as to provide the smoothest wall surface possible. Once the barrier sheet 100 is applied to the outer surface of the drywall 102, the barrier sheet 100 can be treated in a manner similar to the manner that one would treat a surface of drywall. In particular, the surface 122 can be painted as discussed above. Additionally, wallpaper can be applied over the surface 122, and pictures can be hung on the wall.

Having described the invention in detail with respect to certain preferred embodiments, it will be appreciated that variations and modifications exist within the scope and spirit of the invention as defined herein by the appended claims, and their equivalents and the prior art.

What is claimed:

1. An acoustic isolator capable of being placed on a resting surface and receiving a sound producing device, the acoustic isolator comprising:
a. a sheet like barrier member having a first surface and a second surface and a thickness of less than about 0.375 inches, the barrier being comprised of a plastic material, and
b. a sheer like fiber based fabric member having a first surface coupled to the second surface of the barrier member to form a laminated sheet having at least two layers.

2. The acoustic isolator of claim 1 wherein the barrier member comprises a vinyl acetate barrier member.

3. The acoustic isolator of claim 2 wherein the vinyl acetate barrier member comprises a mineral loaded ethyl vinyl acetate barrier member.

4. The acoustic isolator of claim 3 wherein the barrier member has a thickness of between about 0.125 and 0.375 inches.

5. The acoustic isolator of claim 2 wherein the fabric member comprises a non-woven fiber based fabric member including at least one of polyester fibers and polypropylene fibers.

6. The acoustic isolator of claim 1 wherein the fiber based fabric member comprises one of a polyester fiber predominant fabric and a polypropylene fiber predominant fabric.

7. The acoustic isolator of claim 1 wherein the fiber based fabric member comprises a solution dyed, non-woven staple fiber containing fabric having sufficient flexibility to permit the isolator to be rolled up and placed in a sack like container for transportation and storage.

8. The acoustic isolator of claim 7 wherein the sack like container includes a cinch type closure mechanism, and the fiber based fabric member comprises a staple non-woven fabric containing post-consumer recycled fibers.

9. The acoustic isolator of claim 8 wherein the fiber based fabric member includes at least one of a fire retardant additive and an anti-microbial additive.

10. The acoustic isolator of claim 9 wherein the isolator has a length of at least about six feet and a width of at least about four feet for accommodating a drum set.

11. A paintable acoustic barrier sheet capable of being attached to and covering a room surface member, and receiving a paint material to permit the user to choose the color of covered room surface member by applying paint thereto, the paintable acoustic barrier sheet comprising
a sheet like barrier member for serving to reduce the passage of sound energy there through having a first surface, a second surface and of a thickness of less than about 0.25 inches, the barrier member being comprised of a first plastic material,
a sheet like plastic second paintable member comprised of a second plastic material and having a first surface coupled to the second surface of the barrier member to form a laminate having at least two layers, and a second surface, the second surface being capable of receiving paint in a manner that permits the paint to adhere to the first surface in an even aesthetically pleasing manner.

12. The paintable acoustic barrier sheet of claim 11 wherein the sheet like barrier member comprises a vinyl acetate plastic sheet.

13. The paintable acoustic barrier sheet of claim 12 wherein the vinyl acetate plastic sheet comprises a mineral loaded ethylene vinyl acetate sheet.

14. The paintable acoustic barrier sheet of claim 13 wherein the barrier sheet has a thickness of between about 0.125 and 0.250 inches.

15. The paintable acoustic barrier sheet of claim 14 wherein the barrier member has a thickness of less than about 0.150 inches.

16. The paintable acoustic barrier sheet of claim 11 wherein the first surface of the barrier member is capable of receiving an adhesive for adhesively adhering the barrier sheet to the room surface member.

17. The paintable acoustic barrier sheet of claim 11 wherein the first surface of the barrier member includes an adhesive material attached thereto for adhesively adhering the barrier sheet to the room surface member.

18. The paintable acoustic barrier sheet of claim 11 wherein the second paintable member is comprised of a plastic material having a class A fire rating.

19. The paintable acoustic barrier sheet of claim 18 wherein the plastic material comprises a polyvinyl chloride plastic.

20. The paintable acoustic barrier sheet of claim 11 wherein the second paintable member has a thickness of about 0.022 inches and the room surface member comprises at least one of a floor member, a ceiling member and a wall member.
